(19) United States
(12) Patent Application Publication
(10) Pub. No.: US 2026/0184290 A1
(43) Pub. Date: Jul. 2, 2026

(54) EMERGENCY SYSTEM TO DRIVE A VEHICLE

(71) Applicant: Khalid ALKHALDI, Riyadh (SA)

(72) Inventor: Khalid ALKHALDI, Riyadh (SA)

(21) Appl. No.: 18/917,713

(22) PCT Filed: Jul. 13, 2024
(86) PCT No.: PCT/SA2024/050017

§ 371 Date: Oct. 16, 2024

(30) Foreign Application Priority Data
Oct. 16, 2023 (SA) 123450596

(51) Int. Cl. B60S 9/215; B60K 26/02; B60T 7/06

(52) U.S. Cl. CPC B60S 9/215; B60K 26/02; B60T 7/06; B60K 2026/026

(57) ABSTRACT

The invention relates to an emergency system to drive a vehicle in emergency situations when they are exposed to malfunctions that prevent them from moving. It contains spare wheels powered by an electric motor and hiddenly installed under the interior of the vehicle, including two rear wheels mounted at two ends of a rear horizontal axis, and two front wheels mounted at two ends of a front horizontal axis, and hydraulic arms installed in a horizontal beam under the vehicle chassis and extends vertically down to connect the beam and the wheel axle. The hydraulic arms operate to lower and lift the spare wheels in emergency situations, as the driving force of the hydraulic arms lowers the spare wheels and lifts the vehicle and the main wheels of the vehicle from the level of the road, allowing the spare wheels to control moving and steering the vehicle. The lifting and lowering of the hydraulic arms and the spare wheels are controlled by a control panel installed inside the driving cabin, in addition to special spare pedals, one for acceleration and another for the brake. The vehicle is steered via the main steering wheel (steering wheel) with a spare steering column connected to it and to the connecting column between the front wheels. Commands to the parts of the system are organized and executed via a control panel with the emergency system, the entire system is powered by a control panel, controller, and spare wheel motor with its own spare battery.

### BACKGROUND OF THE INVENTION

This invention relates to an emergency system for driving and moving vehicles in emergency situations when they are exposed to malfunctions that prevent them from moving. It is a spare wheel hidden under the interior of the vehicle that operate with an electric motor to control hydraulic arms that control lowering and lifting them when needed to move the vehicle.

One of the closest prior art cases is Saudi patent application No. 121420431, which describes a device that is installed behind the vehicle (not integrated with the vehicle) and contains only two wheels. Therefore, lifting the vehicle only lifts the rear wheels from the road and not the four wheels as in our invention. If the described invention is applied in the prior art, The vehicle whose front wheels are damaged will not be able to be moved by the device. In addition, the device described in the prior art works on the vehicle's battery itself, which will not last long—in the event of a failure of the vehicle's motor or battery—in supplying the device described in the prior art with energy to move the vehicle an appropriate distance to reach a repair shop. Therefore, it is only suitable as a device independent of the vehicle in the event that the motor breaks down and the front wheels of the vehicle are not damaged. However, it will occupy a large space to be stored in the vehicle for use in times of emergency, unlike our device that is integrated into the vehicle and stored underneath it in a hidden manner for use in times of emergencies and operates using a special battery capable of supplying it with energy for a long period of time.

One of the closest prior art cases to our invention is described in U.S. Pat. No. 9,758,133, which describes a vehicle emergency system that allows the vehicle to be moved and consists of small wheels that are lowered by a hydraulic arm. These wheels are located behind each wheel of the vehicle and lift the vehicle and its wheels off the road a small amount. These wheels are only used to guide the vehicle to the right or to the left to assist in park the vehicle. It does not move the vehicle forward and backward, and it is not possible to control the vehicle's steering in different directions. The joystick attached to the spare wheels in the prior art controls the vehicle's steering to the right or left only and controls its speed. The wheels derive energy from the vehicle. In our invention, there is a special motor for the spare wheels, and the front wheels can be directed to the right and left. The motor works to move the entire vehicle after lifting it on the four spare wheels and walking with it for distances determined by the life of the battery attached to the system, which supplies the electric motor for the additional wheels with the energy necessary for its work. Our invention operates when the vehicle's main motor is completely stopped, unlike that described in the prior art.

Among the prior arts is described in Chinese patent document No. CN217074292U, which describes small wheels close to the original wheels of the vehicle, which are lowered individually in the event that the main wheel breaks down or needs to be replaced, so the small wheel lifts the vehicle so that the original wheel can be changed. If it is not possible to change the original wheel, the additional wheel can be used and driven. This invention relies on the vehicle's motor to operate the additional wheels, and the additional wheel cannot be directed because each wheel is independent of the other and not connected to the steering wheel for steering, unlike what is described in our invention, where there is a motor to move the additional wheels and direct two of them to the right and left, use the additional wheels and the entire system as a vehicle that can be completely controlled and independent of the original vehicle.

### GENERAL DESCRIPTION OF THE INVENTION

This invention aims to provide an emergency system used to drive vehicles when they are exposed to malfunctions, especially malfunctions that hinder their movement from their location, such as accidents, fuel exhaustion, motor failure, battery failure, etc. The emergency system for moving vehicles contains four wheels, the front two wheels on a front axle and the two rear wheels on a rear axle. Each axle is connected via two hydraulic arms to a horizontal beam parallel to the axle and connected to the chassis. The hydraulic arms operate to lower the spare wheels from their hiding place under the vehicle to the level of the road, lifting the vehicle and its wheels off the road, allowing the spare wheels in the system to move the stalled vehicle. The spare wheels have an electric motor connected to either the rear or front wheels. The motor derives its electrical energy from a battery that derives energy from the vehicle's main motor and stores it until needed for use. It can also be charged independently. The steering of the two front spare wheels is controlled via the vehicle's steering wheel, which is equipped with a spare steering column connected to the two spare wheels. The spare steering column is connected to the main steering column via a gear that connects them. The vehicle is equipped with an additional brake pedal and acceleration pedal that are hidden above the vehicle's original pedals under the vehicle's décor and they can be lowered via the system control panel located inside the vehicle's cabin. These pedals operate with the steering wheel to control the system described in this invention for moving a disabled vehicle.

### BRIEF DESCRIPTION OF THE DRAWINGS

FIG. 1 is a general view of the invention in the closed position of the system and the wheels are lifting.

FIG. 2 is a side view in the operating mode of the system and lifting the vehicle and the main wheels from the road level after lowering the spare wheels via the hydraulic arms.

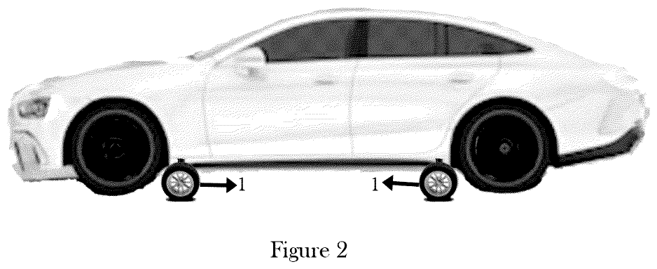

FIG. 3 is a view showing the front and rear spare wheels, the axles carrying them, the hydraulic arms, and the two crossbars connected to the chassis.

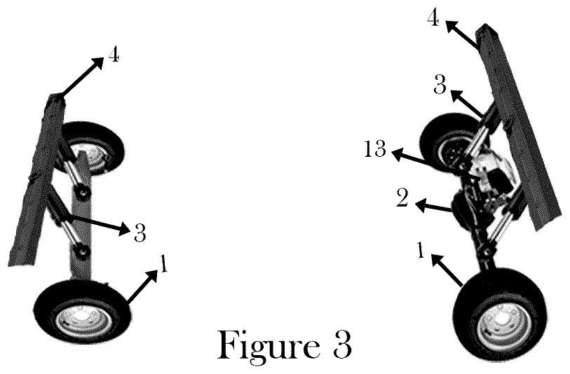

FIG. 4 is a view showing the control panel and its parts.

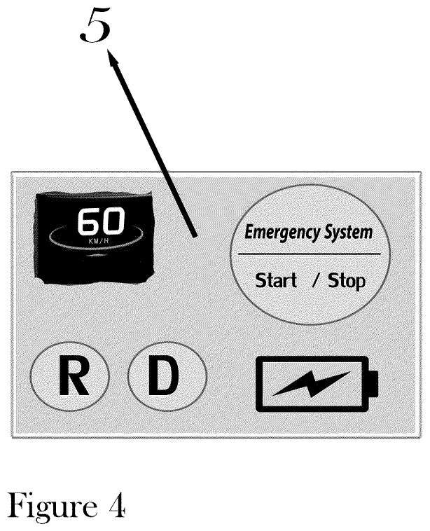

FIG. 5 is a view showing the accelerator pedal, the brake pedal, and their movable holder in the open position.

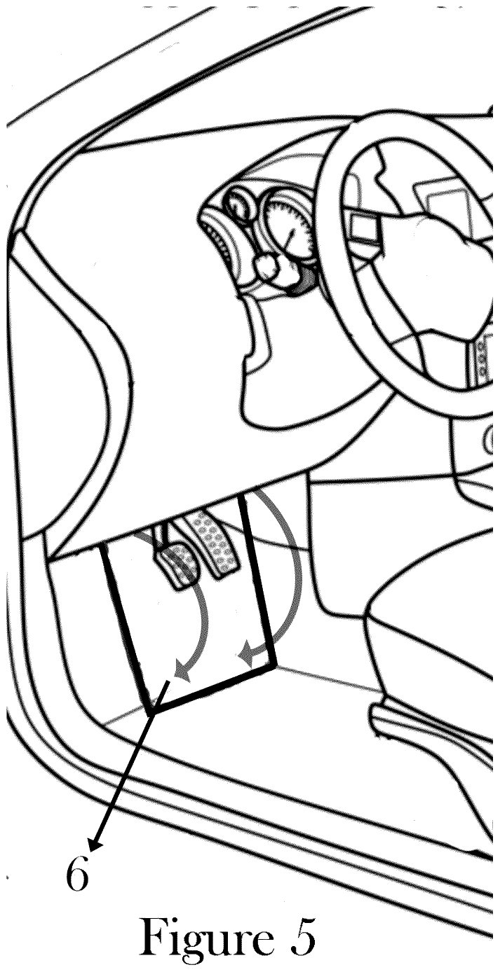

FIG. 6 is a view showing the shaft for steering the front spare wheels, which is connected to the shaft connecting the wheels and connected to the steering wheel via an iron gear.

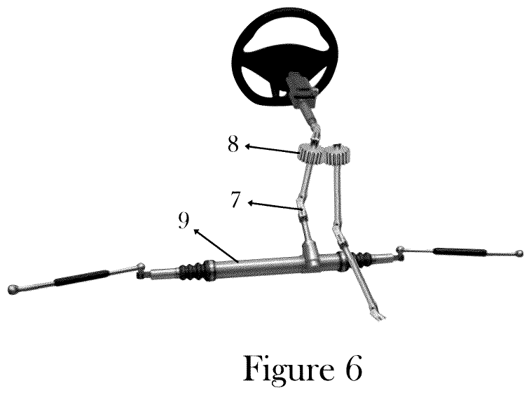

FIG. 7 is a view showing the system battery.

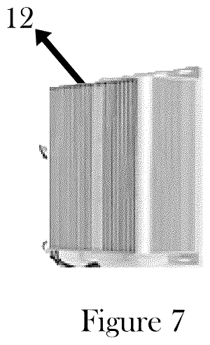

FIG. 8 is a view showing the system's control device.

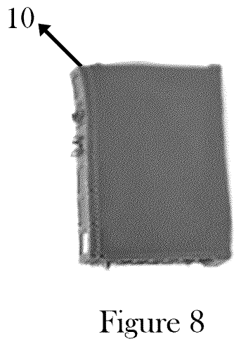

### DETAILED DESCRIPTION

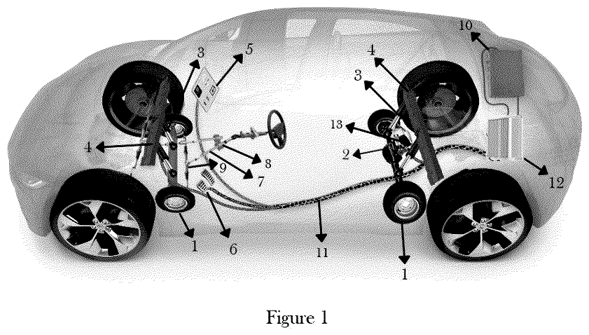

The present invention is an emergency system for driving vehicles when they are exposed to malfunctions that prevent them from moving, which is comprehensively shown in FIG. 1. It consists of spare wheels (1) powered by an electric motor (13), which operates on the battery (12) to move the front or rear wheels (1). The wheels (1) and motor (13) are hidden at the bottom of the vehicle and consist of two rear wheels (1) mounted at the ends of a horizontal column representing the rear axle (2), and two front wheels (1) mounted at the ends of a horizontal column representing the front axle (2). Hydraulic arms (3) are installed vertically in the axle (2), and the hydraulic arms (3) connect horizontal beams (4) installed in the vehicle chassis and the axle (2) parallel to it, in order to remove the spare wheels (1) from their hiding place in the event of an emergency and vice versa. Each axle (2) has at least two hydraulic arms (3). Each hydraulic arm (3) connects the axle (2) and the horizontal beam (4) parallel to it, and each horizontal beam (4) is connected to the vehicle chassis. By extending the hydraulic arms (3), the front and rear axles (2) descend with the wheels (1), and the wheels (1) work to lift the vehicle off the road, allowing only the spare wheels (1) to move the vehicle. By contracting the hydraulic arms (3), the front and rear axle (2) rises, and the vehicle's original wheels return to the road.

The operation of the system, the lowering of the hydraulic arms (3) and the spare wheels (1), and the choice of the direction of travel forward or backward are controlled via the control panel (5) located in the driving cabin, and the vehicle is directed to increase, decrease, and stop speed via the accelerator and brake pedal holder (6) installed in a holder (6) that moves up and down, and the holder (6) is fixed in a hidden manner in the decoration ceiling under the steering wheel, and the holder (6) is opened and lowered when needed in case of emergency situations and exposure to malfunctions that prevent the vehicle from moving. The vehicle is steered via the main steering wheel and the spare steering column (7) connected to it and connected to the column connecting the front spare wheels (9) via a gear (8) to connect the connecting column (9) to the main steering column. Commands for the parts of the system issued by the control panel (5) and the accelerator and brake pedals (6) are organized via the system's controller (12). All parts of the system are fed via its own battery (12), and data and commands are transferred from the control panel (5) and pedals (6) to the controller (10) via data transmission wiring harness (11).

The battery (12) is charged from the vehicle's electrical circuit while the vehicle is operating normally. In the event that the emergency system in this invention is activated and the vehicle's main motor stops working, and its electrical circuit stops, the energy previously stored in the battery (12) is utilized to fully activate the emergency system. The battery (12) attached to the system can also be charged via an independent charging socket.

1. The emergency system to drive vehicle contains:
Four wheels (1), the two front wheels are at two ends of a front axle (2) and the two rear wheels are at two ends of a rear axle (2),
Each axis (2) is connected via two hydraulic arms (3) to a horizontal beam (4) parallel to the axis (2) and connected to the chassis,
For the spare wheels (1), an electric motor (13) is connected to the two rear wheels (1), the motor (13) derives its electrical energy from a battery (12) that derives energy from the vehicle's main motor and stores it until needed for use,
The steering of the two front spare wheels (1) is controlled via the vehicle's steering wheel, which is equipped with a spare steering column (7) connected to the two front spare wheels (1), and the spare steering column (7) is connected to the main steering column (9) via a gear (8) that connects them,
The vehicle is equipped with an additional brake pedal and acceleration pedal (6) hidden above the two original pedals of the vehicle under the vehicle's decoration, and they can be lowered via the control panel (5) of the system located inside the vehicle's cabin. These pedals (6) work with the steering wheel to control the system described in this invention to move the disabled vehicle,
The hydraulic arms (3) operate through the control panel (5) to lower the spare wheels (1) from their hiding place under the vehicle to the level of the road to lift the vehicle and its wheels off the road, allowing the spare wheels (1) using the electric motor (13) to move the disabled vehicle. Through the control panel (5), the direction forward or backward can be determined, and using the pedals (6) the vehicle's acceleration can be controlled or stopped.

2. An emergency system to drive vehicle in accordance with claim (1), where the motor (13) moves the two front wheels (1).

3. An emergency system to drive vehicle in accordance with claim (1), where the battery (12) attached to the system derives energy from the vehicle's electrical circuit while it is operating and stores it until it is used to operate the emergency system.

4. An emergency system to drive vehicle in accordance with claim (1), where the battery (12) attached to the system derives energy from an external source of electricity.

5. An emergency system to drive vehicle in accordance with claim (1), where the spare steering column (7) is connected via toothed gears (8) to the main steering wheel and connected to a connecting column (9) between the spare front wheels.

6. An emergency system to drive vehicle in accordance with claim (1), in which a control panel (5) for the system is installed inside the driving cabin and contains buttons to start and stop the system, choose the direction of travel forward or backward, a speedometer, and a battery indicator.

7. An emergency system to drive vehicle in accordance with claim (1), where the accelerator pedal and brake pedal (6) are mounted on a holder that moves up and down, and the holder is hiddenly installed in the decoration ceiling under the steering wheel, and the holder (6) is opened and lowered down in times of emergency via the control panel (5).
